(19) United States
(12) Patent Application Publication
(10) Pub. No.: US 2008/0080707 A1
(43) Pub. Date: Apr. 3, 2008

(54) RSA signature authentication with reduced computational burden

(76) Inventor: Shay Gueron, Haifa (IL)

Correspondence Address: INTEL/BLAKELY, 1279 OAKMEAD PARKWAY, SUNNYVALE, CA, 94085-4040, US

(21) Appl. No.: 11/540,213

(22) Filed: Sep. 29, 2006

(51) Int. Cl. H04L 9/30

(52) U.S. Cl. 380/30

(57) ABSTRACT

Methods and apparatuses enable quick authentication of a Rivest, Shamir, and Adleman (RSA) compliant signature by performing non-modular arithmetic operations on one or more pre-computed constants in place of at least one modular arithmetic operation. In one embodiment, the signature is authenticated by computing S^{E} (mod N) by performing k non-modular arithmetic squaring operations, k+1 non-modular arithmetic subtraction operations, k+2 non-modular arithmetic multiplication operations, and no modular arithmetic, where S is the RSA compliant signature, E is the exponent of a public key, N is the modulus of the public key, and k is a positive integer where E=2^{k}+1.

### FIELD

Embodiments of the invention relate to public-key cryptography, and more particularly to quickly authenticating a message signed with a Rivest, Shamir, and Adleman (RSA) compliant signature with a reduced computational burden.

### BACKGROUND

Public-key cryptography allows two parties to communicate securely without the need for prior access to a shared secret key. Instead, a pair of mathematically related cryptographic keys, one public and widely distributed, and one private, are used. Public-key cryptography can be applied to digitally sign a message. A digital signature is conceptually similar to a signet and serves to ensure both the identity of the author and authenticity of the message.

One form of public-key cryptography is the Rivest, Shamir, and Adleman (RSA) algorithm. A standard application of the RSA algorithm to digitally sign a message involves using two randomly generated, large prime numbers, P and Q, from which public and private keys are created. The public key consists of a public exponent, E, and modulus, N, and is distributed to any number of signature authentication devices. The private key consists of a private exponent, D, and the same modulus, N.

A digital signature, S, is created by computing S=M^{D} (mod N), where M is known as the digest of the message and is the hash-value of a pre-defined hash-function (e.g., Secure Hash Algorithm 1 (SHA-1)) performed on the data to be sent, D is the private exponent of the private key, and N is the modulus of the private key. The digital signature is then transmitted by the server along with the data of the message and public key across a network to any number of authentication devices.

The authentication devices use the sender's widely distributed public key to authenticate the digital signature, thereby verifying the identity of the sender and validity of the message. Upon receiving a message signed with an RSA compliant digital signature, the authentication device first validates the received public key, consisting of a public exponent, E, and modulus, N, by comparing it to an expected value (e.g., a copy known to be valid). The public key is only validated if it is identical to the expected value. If the public key is found to be valid, then the validity of the signature is tested. To validate the signature, a local message digest, R, is computed as the result of the hash function used by the sender, performed on the received message. The local message digest, R, is then compared to A, where A=S^{E} (mod N), where S is the digital signature, E is the public exponent of the public key, and N is the modulus of the public key. If R and A are identical, then the signature is considered valid.

In a standard processor architecture, the computation of S^{E} (mod N) in the authentication process consumes most of the processor time given the complexities of modular arithmetic. In certain applications of RSA signature authentication technology long latency during authentication can be particularly problematic (e.g., uninterruptible installation of microcode patch uploads). Conversely, time constraints are generally less stringent during signing. Additionally, while a message will only be signed by one sending device, it may be independently authenticated by a large number of receivers, all needing to individually perform computationally costly modular arithmetic.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram of an embodiment of a network configuration having a server and authentication clients.

FIG. 2 is a block diagram of an embodiment of an authentication client with a library of public keys.

FIG. 3 is a block diagram of an embodiment of a signed message.

FIG. 4 is a flow diagram of an embodiment of a process for signing and authenticating a message.

### DETAILED DESCRIPTION

As used herein, references to one or more “embodiments” are to be understood as describing a particular feature, structure, or characteristic included in at least one implementation of the invention. Phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, with an overview description of embodiments of the invention, followed by a more detailed description with reference to the drawings.

One method of authentication of a digital message signed according to the Rivest, Shamir, and Adleman (RSA) Cryptography Standard 2.1 (RSA Standard), Public-Key Cryptography Standards #1 version 2.1, published Jun. 14, 2002, available from RSA Laboratories, Bedford, Mass., U.S.A., involves the computation of S^{E} (mod N) (hereinafter “RSA modulus computation”), where S is the signature, E is the exponent of a public key, and N is the modulus of that key. In a traditional system, a message server transmits the data of the message, M, an RSA compliant signature, and public key, from which the authentication device calculates the RSA modulus computation using modular arithmetic.

The RSA signature authentication process can be simplified by pre-computing various components of the RSA modulus computation, which allows authentication devices to perform the computation with reduced or completely without processor-time intensive modular arithmetic. In one embodiment, this is accomplished by calculating K+1 pre-computed constants prior to sending the signed message, where E=2^{K}+1 for an integer K>=1, where E is the exponent of the public key of the message. The pre-computed constants are then sent along with the message to a plurality of authentication devices. Each authentication device proceeds to authenticate the RSA compliant signed message by performing K standard arithmetic squaring operations, K+1 standard arithmetic subtraction operations, and K+2 standard arithmetic multiplication operations performed on the pre-computed constants and other components of the signed message to calculate the RSA modulus computation. For example, in one embodiment, for a public exponent, E, set to three, two pre-computed constants, Q1 and Q2, could be used to perform the RSA modulus computation by calculating

(S²−Q1*N)*S−Q2*N

using only standard arithmetic in place of at least one modular arithmetic computation, where

Q1=FLOOR(S²/N) and

Q2=FLOOR((S³−Q1*S*N)/N).

Thus, a message signed according to the RSA Standard can be authenticated at least in part by substituting standard arithmetic operations performed on the pre-computed constants into the verification process in place of the traditional modular arithmetic calculation of the RSA modulus computation.

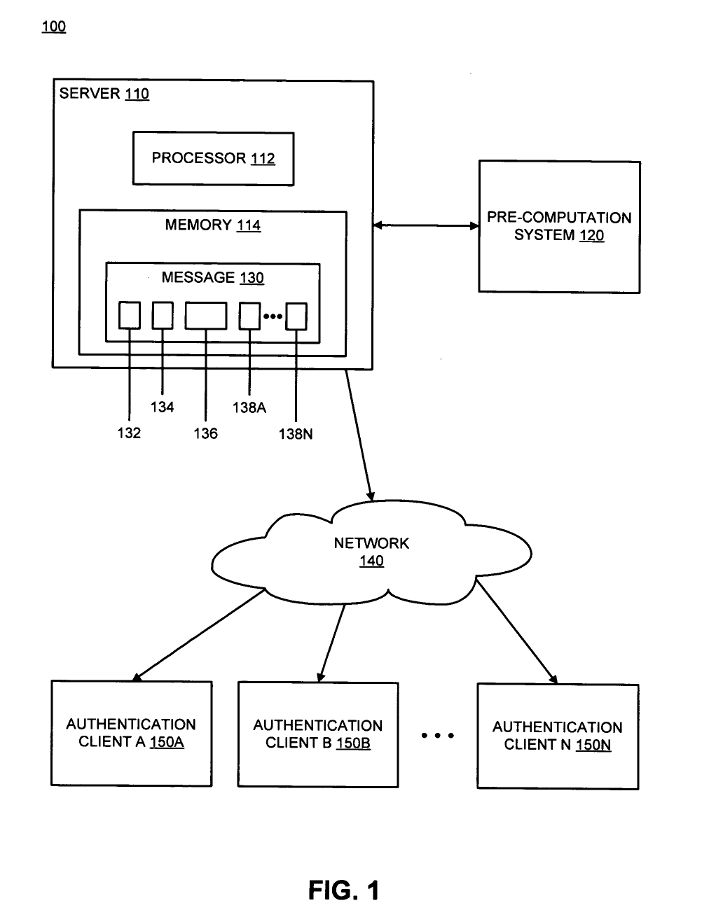

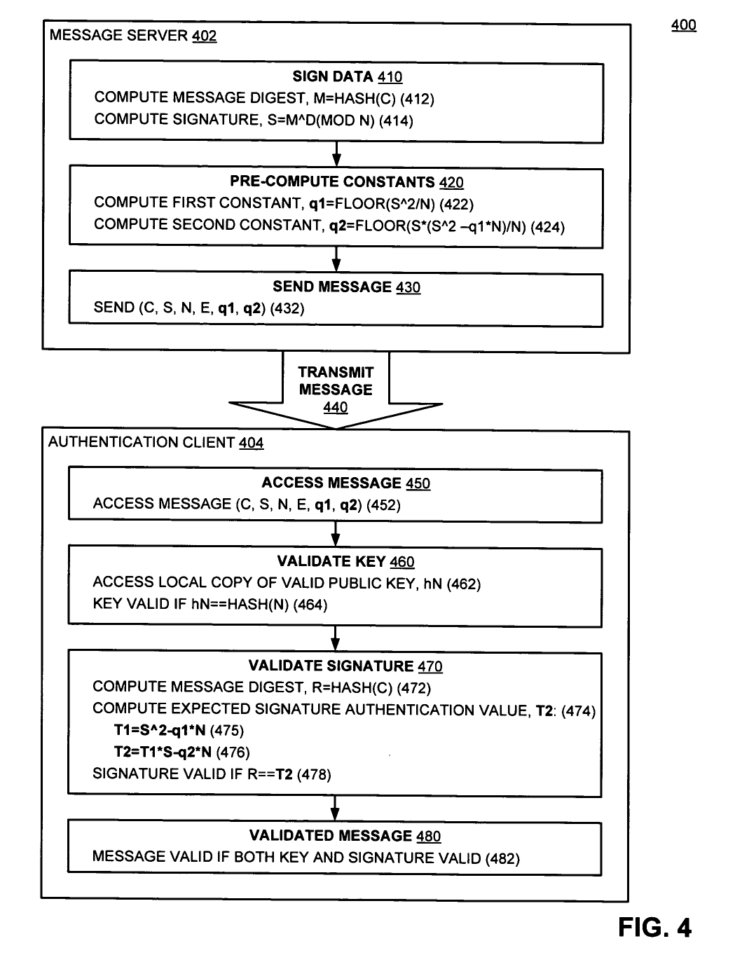

FIG. 1 is a block diagram of an embodiment of a network configuration having a server and authentication clients. FIG. 1 is only one example of a possible network configuration; other configurations are also possible. More specifically, FIG. 1 shows block diagrams of server 110, pre-computation system 120 coupled to server 110, one or more authentication clients 150, and network 140 coupling sever 110 to clients 150. Server 110 is one example of a system responsible for signing and transmitting a message as described herein, such as message server 402 of FIG. 4.

Server 110 includes one or more processors 112 and memory 114 coupled to processor 112. Server 110 may be any machine capable of processing, storing, and transmitting digital data (e.g., a mainframe, file server, web server, or authentication server). In one embodiment, server 110 is responsible for transmitting message 130 stored in memory 114 to one or more of clients 150. Message 130 includes message data 132, RSA compliant signature 134, public key 136, and one or more pre-computed constants 138. Server 110 may either access or generate signature 134 to correspond to message data 132 and public key 136. Once signature 134 and public key 136 have been determined, server 110 requests pre-computation system 120 to calculate one or more pre-computed constants 138 to be used in the message signing process. Pre-computed constants 138 are calculated according to the RSA modulus computation. In an alternative embodiment, server 110 could calculate pre-computed constants 138 in processor 112.

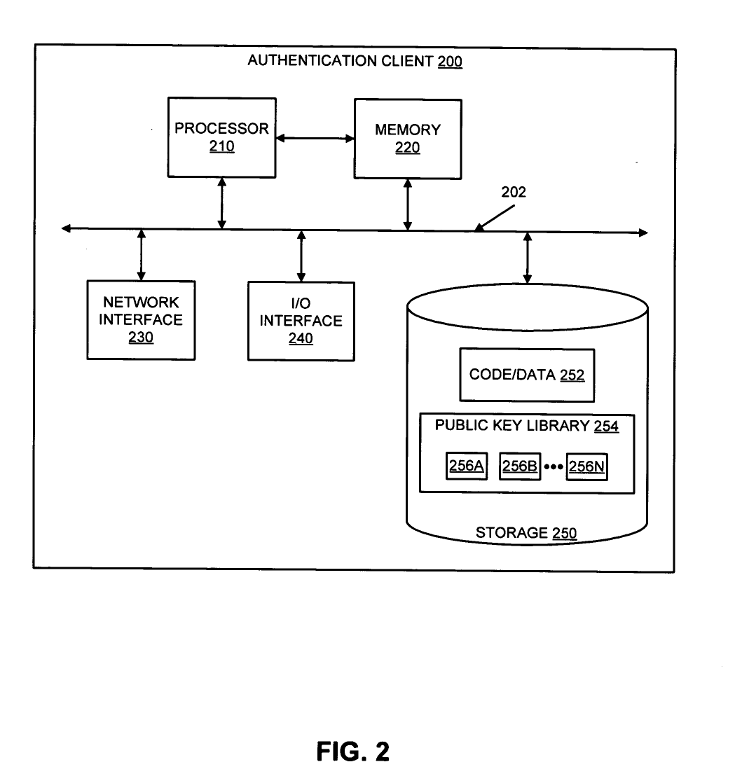

FIG. 2 is a block diagram of an embodiment of an authentication client with a library of public keys. Authentication client 200 may be, for example, a personal computer, handheld computer, gaming system, set-top box, cell phone, etc. Authentication client 200 is an illustration of a system used to authenticate signed messages as described herein, and may be one example of authentication clients 150 of FIG. 1 and 404 of FIG. 4. Authentication client 200 includes one or more processors 210, and memory 220 coupled to processor 210. Processor 210 may include any type of microprocessor, central processing unit (CPU), processing core, etc., to perform operations related to message authentication and servicing of data access requests. Processor 210 controls the overall operation of authentication client 200, and may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 220 represents the main memory of authentication client 200 to provide code or data to be executed by processor 210. Memory 220 may include read-only memory (ROM), flash memory, one or more varieties of random access memory (RAM, e.g., static RAM (SRAM), dynamic RAM (DRAM), synchronous DRAM (SDRAM), etc.), or a combination of memory technologies.

Processor 210 and memory 220 are coupled to bus system 202. Bus system 202 is an abstraction that represents any of one or more separate physical buses, communication lines/interfaces, and/or multi-drop or point-to-point connections, connected by appropriate bridges, adapters, and/or controllers. Therefore, bus system 202 may include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronic Engineers (IEEE) standard 1394-1995 bus, published Aug. 30, 1996, commonly refereed to as “Firewire.”

Also coupled to processor 210 through bus system 202 are one or more network interface(s) 230, one or more input/output (I/)) interface(s) 240, and one or more internal storage device(s) 250. Network interface 230 enables authentication client 200 to communicate with remote devices (e.g., a server) over a network and may be, for example, an Ethernet adapter. Additionally, authentication client 200 would likely be made to be accessible to a human user, and thus have video, audio, and/or alphanumeric interface(s) through I/O interface 240.

Storage 250 may be or include any conventional medium for storing data in a non-volatile manner. Storage 250 holds data and/or instructions in a persistent state (i.e., the value is retained despite interruption of power to authentication client 200). Storage 250 includes code and/or data 252 that may be accessed and placed in memory 220 for execution by processor 210.

Storage 250 also holds public key library 254, containing one or more public keys 256 that may be accessed and placed in memory 220 for use in the authentication process by processor 210. Public key library 254 may be a database, table, etc. In one embodiment, public key library 254 is a cross-listing of valid public keys to sender identities, used in the authentication process to compare to and validate the public key of a received message. In an alternative embodiment, public key library 254 holds a unique simplification of valid public keys, for example, as computed by a pre-defined hash-function (e.g. Secure Hash Algorithm 1 (SHA-1), Secure Hash Algorithm 256 (SHA-256), Message-Digest algorithm 5 (MD5)). In another alternative embodiment, public key library 254 may be maintained and stored on a remote system, such as a public key server, and accessed by authentication client 200 remotely.

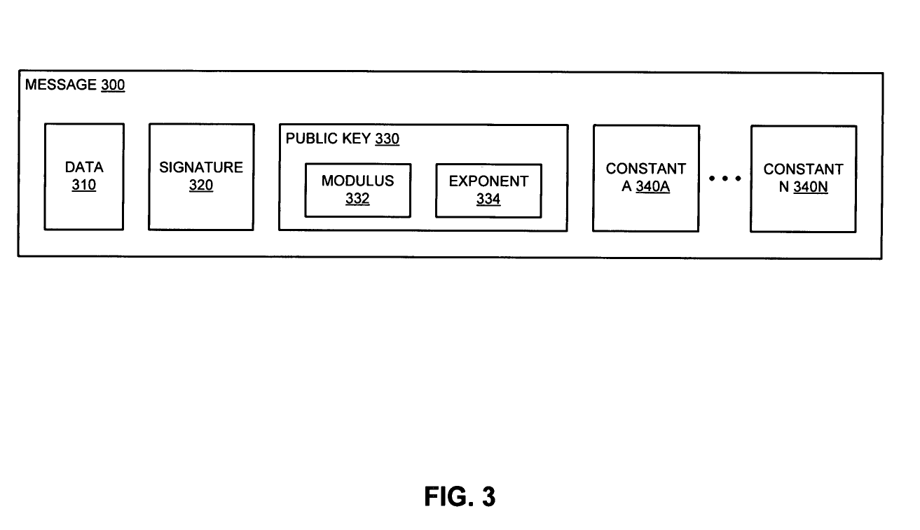

FIG. 3 is a block diagram of an embodiment of a signed message to be authenticated according to an RSA compliant procedure. Message 300 is one example of a message such as message 130 in FIG. 1 and the message sent and received in the operations of FIG. 4. As shown, message 300 contains several components including data 310, signature 320, public key 330 having modulus 332 and exponent 334, and one or more pre-computation constants 340. Note that more pre-computation constants may be available than what is present as pre-computation constants 340 of message 300. Thus, the one or more pre-computation constants 340 may be part or all of available pre-computation constants (i.e., all constants are not necessarily sent).

Data 310 represents the actual information being communicated and authenticated in message 300. In one embodiment, data 310 is unencrypted though it may be encrypted in an alternative embodiment for an added layer of security.

Signature 320 represents an RSA compliant signature computed by a signing server to allow an authentication device to authenticate message 300 (e.g., server 110 and authentication client 150 in FIG. 1, respectively). In one embodiment, signature 320 is equal to M D (mod N), where M is known as the digest of the message and is the hash-value of a pre-defined hash-function performed on data 310, D is the private exponent of a private key, and N is the modulus of the private key.

Note that as used herein, generating a hash of M may include operations other than simply hashing the message. Specifically, practical implementations of RSA pad the message string to ensure that the message is a full-length message (e.g., padding a 160 bit message to a full 2048 bit string) for security purposes. The sending of a short message can make the transaction very insecure as compared to the sending of a full-length message. Padding schemes include PKCS v1.5 of the Public Key Cryptography Standards group, Optimal Asymmetric Encryption Padding (OAEP), and Probabilistic Signature Scheme for RSA (RSA-PSS), as is understood by those skilled in the art. Other standards may be used. As mentioned above, padding schemes are generally part of a practical implementation of RSA, but will not be discussed in detail herein. Where padding schemes are used, it will be understood that reference herein to operations involving a hash of M may be understood as including the implementation of a padding scheme, if one is used. Thus, for simplicity in description, padding schemes are ignored, and may be implied where appropriate.

Public key 330 represents a public key to the authentication of message 300 including modulus 332 and public exponent 334. In an alternative embodiment, exponent 332 may be a pre-determined value that is not transmitted with message 300. Public key 330 is generated according to an RSA compliant process and may be checked for validity against a library of public keys such as public key library 254 in FIG. 2.

Pre-computation constants 340 represent one or more pre-computation constants used in the authentication process. In one embodiment, the number of pre-computation constants is equal to K+1, for a positive integer K where the public exponent of the public key, E, is equal to 2^{K}+1, for any E compliant with the RSA Standard (e.g., 3, 6, and 9).

Message 300 may be sub-divided into any number of packets for transmission across a network according to standard network protocols. Additionally, the various components of message 300 may be calculated by different systems at different times.

FIG. 4 is a flow diagram of an embodiment of a process for signing and authenticating a message. A flow diagram as illustrated herein provides an example of a sequence of various operations. Although shown in a particular sequence or order, unless otherwise specified, the order of the operations can be modified. Thus, the illustrated implementations should be understood only as examples, and operations can be performed in a different order, and some operations may be performed in parallel or alternatively performed only implicitly by way of logical simplification. Other operations, orders of operations, flowcharts and embodiments are also within the scope of the present invention.

FIG. 4 illustrates that data to be transmitted may be signed in message server 402 and verified in authentication client 404. Flow 400 is illustrative of a message signed according to the RSA Standard with a public exponent, E, of three, according to one embodiment. In other embodiments, the public exponent is a different value compliant with the RSA Standard (e.g., 5, 9, and 17).

Message server 402 sends a signed message by signing data, 410, pre-computing constants for the data, 420, and sending the message including the data, signature, and constants, 430. As discussed above, pre-computing of constants, 420, may take place on message server 402, or in the alternative, another system such as pre-computation system 120 of FIG. 1.

In one embodiment, upon accessing data, C, to be transmitted with an RSA compliant signature, message server 402 generates a signature, S, to sign the data for transmission, 410. Signing the data includes computing a message digest, M, as the result of a pre-defined hash-function performed on the data, 412. The signature is computed as the result of MD (mod N), 414, where M is the message digest, D is the exponent of the sender's private key, and N is the modulus of the private key.

Given a signature, pre-computed constants may be calculated to expedite the authentication process, 420. In one embodiment, the number of pre-computation constants is equal to K+1, for a positive integer K where the public exponent of the public key, E, is equal to 2^{K}+1. Thus, when E=3 two pre-computation constants are calculated. Alternatively, if E=17, then five pre-computation constants are calculated. In other embodiments, the public exponent is a value other than 3 that is compliant with the RSA Standard. For example, for E=3, the first pre-computed constant, q1, is calculated as the floor of S²/N, 422, where S is an RSA compliant signature and N is the modulus of the sender's public key. Similarly, the second pre-computed constant, q2, is calculated as the floor of S*(S²−q1*N)/N, 424.

With a message generated and signed, and with pre-computed constants generated, message server 402 sends the signed message including the data of the message, C, an RSA compliant signature, S, a public key having a modulus, N, and an exponent, E, and one or more pre-computed constants, q, 432. In another embodiment, only the data, signature, and pre-computed constants are sent. Transmission of the message, 440, may occur according to standard network transmission protocols, allowing for physical and/or logical division of the message.

Authentication client 404 authenticates a message such as message 300 of FIG. 3 by accessing the message, 450. Authentication client 404 accesses the message, signature, and pre-computed constants as sent, 452. In response to receiving/accessing the message, authentication client 404 validates the public key, 460, and the signature, 470. Authentication client 404 can then determine if both the key and the signature are valid to determine if the message is valid, 480.

In one embodiment, authentication client 404 accesses a message including data, C, an RSA compliant signature, S, a public key including a modulus, N, and public exponent, E, and one or more pre-computed constants, q, 452. In an alternative embodiment, authentication client 404 may access the public key from another source known to be valid, such as a public key server or local storage, in which case, it need not be validated.

The public key is validated by comparing it to a trusted copy or one known to be valid, 460. In one embodiment, a listing of public keys is stored locally, such as the library of public keys 254 in FIG. 2. Alternatively, a unique derivative of the keys may be stored, such as the hash-value of a pre-defined hash-function. In such an embodiment, validation of the public key includes accessing a local copy of the hash-value of the modulus of the public key, hN, 462. The received module of the public key, N, is hashed according to the function used to generate the stored hN, and the computed hash is compared to hN. The key is deemed valid if hN and the hash-value of N are equal, 464. In another embodiment, the received public key or a unique derivative there of, such as the hash-value of the modulus, may be compared to a list stored on a public key server.

Authentication client 404 validates the data of the message by comparing the message digest derived from it to the message digest derived from the RSA compliant signature, 470. In one embodiment, a message digest, R, of the data received, C, is computed as the hash-value of a pre-defined hash-function used to sign the message, 472. The message digest, R, is then compared to an expected signature authentication value derived from the RSA compliant signature, S, 474. In a traditional system, the expected signature authentication value, also known as the expected digest, is computed using modular arithmetic to calculate S^{E} (mod N), the RSA modulus computation. As described herein, the expected signature authentication value can be computed without the traditional need for modular arithmetic. In one embodiment, for a public exponent, E, of three, the expected signature authentication value, T2, can be found by computing:

T1=S²−q1*N, 475, and

T2=T1*S−q2*N, 476.

The signature is valid if the message digest, R, is equal to the expected signature authentication value, T2, 478. Note that each equation 475 and 476 uses only standard (e.g., non-modular), rather than modular, arithmetic. Thus S^{E} (mod N) can be computed in a reduced amount of time by substituting standard arithmetic operations performed on the pre-computed constants into an RSA compliant signature authentication process in place of a modular arithmetic calculation, 475, 476.

The message is considered valid and authenticated if both the key and data are valid, 480. Authentication client 404 determines whether the key and signature validations attempts were successful. If both the key and the signature were determined to be valid, authentication client 404 determines that the message is valid, 482.

The descriptions herein of operations and orders of operations, describe components that may include hardware, software, and/or a combination of these. In a case where a component to perform actions described herein includes software, the software data, instructions, and/or configuration may be provided via an article of manufacture by a machine/electronic device/hardware. An article of manufacture may include a machine readable medium having content to provide instructions, data, etc. The content may result in an electronic device as described herein, performing various operations or executions described. A machine readable medium includes any mechanism that provides (i.e., stores and/or transmits) information/content in a form accessible by a machine (e.g., computing device, electronic device, electronic system/subsystem, etc.). For example, a machine readable medium includes recordable/non-recordable media (e.g., read only memory (ROM), random access memory (RAM), magnetic disk storage media, optical storage media, flash memory devices, etc.). The machine readable medium may further include an electronic device having code loaded on a storage that may be executed when the electronic device is in operation. Thus, delivering an electronic device with such code may be understood as providing the article of manufacture with such content described herein. Furthermore, storing code on a database or other memory location and offering the code for download over a communication medium may be understood as providing the article of manufacture with such content described herein.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method comprising:
accessing a digital message having data to be authenticated, a Rivest, Shamir, and Adleman (RSA) compliant signature, a public key having a public modulus and exponent, and a pre-computed constant;
performing computations to generate an expected signature authentication value, the computations including non-modular arithmetic operations on the pre-computed constant that replace at least one modular arithmetic operation; and
comparing the expected signature authentication value to the data to validate the message.

2. The method of claim 1, further comprising:
determining the validity of the public key.

3. The method of claim 1, wherein the public exponent is any E for E=2^{k}+1 for an integer k>=1, and k+1 pre-computed constants are accessed.

4. The method of claim 3, wherein the expected signature authentication value is equal to S^{E} (mod N), where S is the RSA compliant signature and N is the modulus of the public key.

5. The method of claim 3, wherein the non-modular arithmetic operations further comprise k arithmetic squaring operations, k+1 arithmetic subtraction operations, and k+2 arithmetic multiplication operations.

6. An apparatus comprising:
a network interface to access a digital message having data to be authenticated, a Rivest, Shamir, and Adleman (RSA) compliant signature, a public key having a public modulus and exponent, and a pre-computed constant; and
a processor to perform computations to generate an expected signature authentication value, the computations including non-modular arithmetic operations on the pre-computed constant that replace at least one modular arithmetic operation; compare the expected signature authentication value to the data to validate the signature; validate the public key; and authenticate the message if both the public key and signature are valid.

7. The apparatus of claim 6, wherein the public exponent is any E for E=2^{k}+1 for an integer k>=1, and k+1 pre-computed constants are accessed.

8. The apparatus of claim 7, wherein the expected signature authentication value is equal to S^{E} (mod N), where S is the RSA compliant signature and N is the modulus of the public key.

9. The apparatus of claim 7, wherein the non-modular arithmetic operations further comprise k arithmetic squaring operations, k+1 arithmetic subtraction operations, and k+2 arithmetic multiplication operations.

10. An article comprising a machine readable medium having content stored thereon to provide instructions to cause a machine to perform operations including:
accessing a digital message having data to be authenticated, a Rivest, Shamir, and Adleman (RSA) compliant signature (S), a public key having a modulus (N) and an exponent (e), and a pre-computed constant;
performing computations to generate an expected signature authentication value equal to S^{E} (mod N), the computations including non-modular arithmetic operations on the pre-computed constant that replace at least one modular arithmetic operation; and
comparing the expected signature authentication value to the data to validate the message.

11. The article of claim 10, further comprising content to provide instructions for:
determining the validity of the public key.

12. The article of claim 10, wherein the public exponent is any E for E=2^{k}+1 for an integer k>=1, and k+1 pre-computed constants are accessed.

13. The article of claim 12, wherein the non-modular arithmetic operations further comprise k arithmetic squaring operations, k+1 arithmetic subtraction operations, and k+2 arithmetic multiplication operations.

14. A system comprising:
a network interface to access a digital message having data to be authenticated, a Rivest, Shamir, and Adleman (RSA) compliant signature, a public key having a public modulus and exponent, and a pre-computed constant; and
a processor to perform computations to generate an expected signature authentication value, the computations including non-modular arithmetic operations on the pre-computed constant that replace at least one modular arithmetic operation; compare the expected signature authentication value to the data to validate the signature; validate the public key; and authenticate the message if both the public key and signature are valid; and
a dynamic random access memory (DRAM) coupled to the processor and the network interface to store the contents of the digital message.

15. The system of claim 14, wherein the processor is to further determine the validity of the public key.

16. The system of claim 14, wherein the public exponent is any E for E=2^{k}+1 for an integer k>=1, and k+1 pre-computed constants are accessed.

17. The system of claim 16, wherein the expected signature authentication value is equal to S^{E} (mod N), where S is the RSA compliant signature and N is the modulus of the public key.

18. The system of claim 16, wherein the non-modular arithmetic operations further comprise k arithmetic squaring operations, k+1 arithmetic subtraction operations, and k+2 arithmetic multiplication operations.

19. The system of claim 14, further comprising:
an internal storage device holding a library of public keys for validating the public key of the accessed digital message.
